(19) United States
(12) Patent Application Publication
(10) Pub. No.: US 2013/0144495 A1
(43) Pub. Date: Jun. 6, 2013

(54) APPARATUS AND METHOD FOR VEHICLE DOOR CONTROL

(71) Applicant: Jong Il Yu, Yongin (KR)

(72) Inventor: Jong Il Yu, Yongin (KR)

(73) Assignee: HYUNDAI MOTOR COMPANY, Seoul (KR)

(21) Appl. No.: 13/435,466

(22) Filed: Mar. 30, 2012

(30) Foreign Application Priority Data
Dec. 1, 2011 (KR) 10-2011-0127750

(51) Int. Cl. G06F 7/00

(52) U.S. Cl. 701/49

(57) ABSTRACT

Provided is an apparatus for controlling a vehicle door, including a storage unit stores a speed profile corresponding to a plurality of directions and angles of various slopes depending on a specific vehicle model. A slope measure unit measures the direction and angle of slope of the vehicle, and an opening and closing detection unit detects when a door of the vehicle is opened or closed. A controller determines the direction and angle measured by the slope measure unit when the opening and closing detection unit detects whether the door is opened or closed, and controls a door drive unit to control an opening and closing speed of the door based on the speed profile corresponding the detected direction and angle of the slope stored in the storage unit. As a result, a door drive unit opens or closes the door under the control of the controller.

### CROSS-REFERENCES TO RELATED APPLICATIONS

Priority to Korean patent application number 10-2011-0127750, filed on Dec. 1, 2011, which is incorporated by reference in its entirety, is claimed.

### BACKGROUND OF THE INVENTION

1. Field of the Invention

The present invention relates to an apparatus and a method for a vehicle door control, and more particularly, to an apparatus and a method for enabling a user of a vehicle to easily open or close a door of a vehicle while the vehicle is stopped/parked on a vertical or horizontal incline.

2. Description of the Related Art

Typically, a vehicle has at least two or more doors that enable a passenger to enter or exit the vehicle. The doors of a vehicle are designed to be opened or closed easily when a vehicle is stopped or parked on a flat surface. However, when a vehicle is parked on an incline (i.e., either side to side or front to back, hereinafter referred to as a horizontal and vertical incline respectively), a passengers sometimes require additional strength to open or close a door in a direction which opposes gravitational forces.

More specifically, when a child or an elderly or injured person attempts to open/close a door in a direction which opposes gravity, it is often times difficult if not impossible for these types of individuals to operate the door effectively, and thus, there exists a need for a method that enables a passenger to open or close a vehicle door easily without an undue amount of physical strength on the part of the passenger.

Furthermore, when the door is opened or closed in the same direction as the gravitational force, the door open faster than anticipated by the passenger and thus may cause a malfunction in the door or damage other vehicles located in close proximity to the door, and thus, there exists a need for an additional technique to solve this problem as well.

### SUMMARY OF THE INVENTION

The present invention has been made in view of the above problems, and provides a technique for controlling a vehicle door which enables a door to be easily opened and closed by generating a torque when the opening/closing direction of the door is at least opposite gravity, controls the speed at which a door is opened or closed by braking or slowing the speed at which the door is opened/or closed when the direction of opening and closing a door is in the same direction as gravity, so that a user can easily open and close the vehicle door when the vehicle is stopped/parked on a vertical or horizontal incline.

According to an aspect of the present invention, a vehicle door control apparatus includes: a storage unit (e.g., a storage device such as a memory or hard drive) configured to store a speed profile corresponding to a direction and angle of a slope depending on a particular vehicle model; a slope measure unit (e.g., a first sensor) configured to measure the direction and angle of slope of a vehicle; an opening and closing detection unit (e.g., a second sensor) configured to detect whether a door of the vehicle is opened or closed; a controller configured to check the direction and angle measured by the slope measure unit when the opening and closing detection unit detects whether the door is opened or closed, and to control a door drive unit to control an opening and closing speed of the door based on the speed profile stored in the storage unit; and a door drive unit configured to apply a force to the operational structure of the door to open or close the door under the control of the controller.

According to another aspect of the present invention, a vehicle door control method includes: storing a speed profile corresponding to a direction and angle of slope depending on a which vehicle model the exemplary embodiment of the present invention is installed, by a storage unit; detecting whether a door of a vehicle is opened or closed, by an opening and closing detection unit; measuring the direction and angle of slope of the vehicle, by a slope measure unit; and controlling an opening and closing speed of the door based on the speed profile stored in the storage unit, by a door drive unit under the control of a controller.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a door control apparatus of a vehicle according to an exemplary embodiment of the present invention;

FIG. 2A-B is an example diagram illustrating a direction and angle of slope of a vehicle according to an exemplary embodiment of the present invention; and

FIG. 3 is a flowchart illustrating a door control method of a vehicle according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

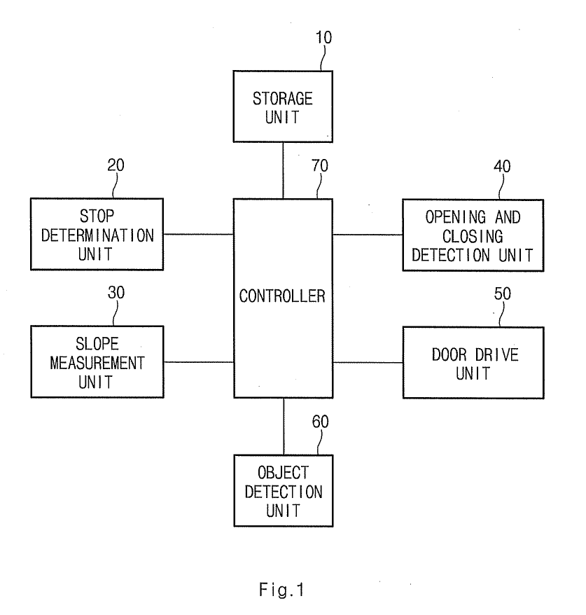

FIG. 1 is a block diagram illustrating a configuration of a door control apparatus of a vehicle according to an exemplary embodiment of the present invention.

As shown in FIG. 1, a door control apparatus of a vehicle according to an exemplary embodiment of the present invention includes a storage unit 10 (e.g., a storage device such as a memory or a hard drive), a stop determination unit 20, a slope measurement unit 30, an opening and closing detection unit 40, a door drive unit 50 and an object detection unit 60.

Each element will be described in detail. First, the storage unit 10 stores torque values and braking values required for the opening and closing of door based on a vertical slope or a horizontal slope of a vehicle. Here, each torque value and the braking value is a value that reflects the weight or/and size of the door depending on that specific vehicle model.

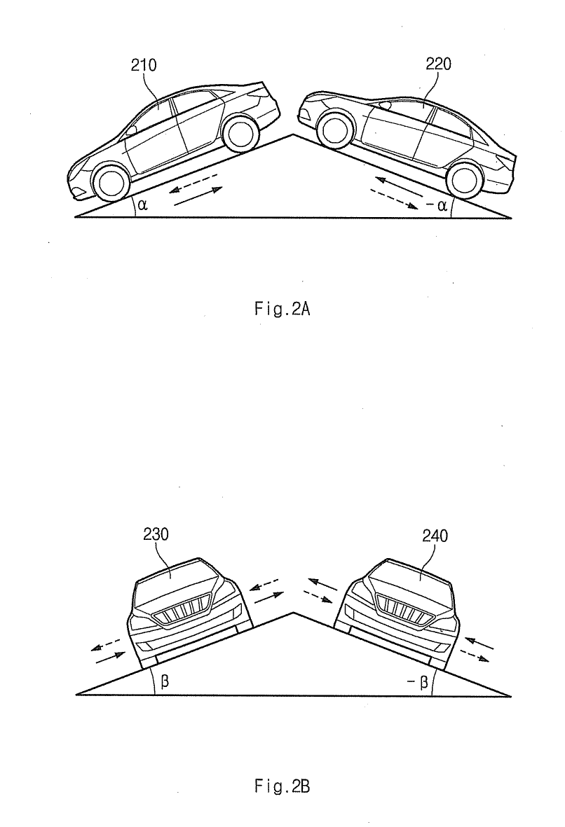

Namely, the torque value and the braking value vary as the ramp inclination type varies, for instance, whether the vehicle is stopped/parked on a vertical incline or ramp as shown in FIG. 2A, or whether the vehicle is stopped/parked on a horizontal incline or ramp as shown in FIG. 2B.

In addition, the torque value and the braking value also vary as the slope value varies. For instance, a vehicle stopped/parked on the front side of the vertical incline ramp 210, has a vertical slope value (α) which is a positive (+) value, (α). However, when vehicle is stopped/parked on the back side of the (i.e., with the back bumper lower than the front bumper) of vertical incline 220, the slope value (α) has a negative (−) value, (−α).

Furthermore, for example, when the vehicle is stopped/parked on a left ramp horizontal incline/ramp 230, the slope value (β) has a positive (+) value, (β), Conversely, when the vehicle is stopped/parked on a right ramp of the horizontal incline/ramp 240, (i.e. when the driver's side of the car is lower than the passenger's side) the slope value (β) has a negative (−) value, (−β).

Finally, the storage unit 10 stores a torque value and a braking value corresponding to the slope value in a table format based on the various cases mentioned above.

For example, in case of ‘210’, since the opening direction of the vehicle door is in the same direction as gravity, the control value required to open the door is a braking value, and the control value required to close the door is a torque value. In the same manner, this is applied to both the front doors and the rear doors of the vehicle.

In case of ‘220’, since the opening direction of the vehicle door is opposite to gravity, the control value required to open the door is a torque value, and the control value required to close the door is a braking value. In the same manner, these values and corresponding forces are applied to both the front doors and the rear doors of the vehicle in this scenario.

Also, in case of ‘230’, since the opening direction of the left doors of the vehicle is in the same direction as gravity, the control value required to open the door is a braking value, and the control value required to close the door is a torque value. Here, however, since the opening direction of the right door of the vehicle is opposite that of gravity, the control value required to open the door is a torque value, and the control value required to close the door is a braking value on the right hand side of the vehicle.

On the contrary to this, in case of ‘240’, since the opening direction of the left door of the vehicle is opposite that of gravity, the control value required to open the door is a torque value, and the control value required to close the door is a braking value on the left hand side of the vehicle. Likewise, since the opening direction of the right door of the vehicle is the same as gravity, the control value required to open the door is a braking value, and the control value required to close the door is a torque value on the right hand side of the vehicle.

As a result, when the opening direction of the door is opposite to gravity, a torque value is needed, whereas when the opening direction of the door is same as gravity, a braking value is needed. Here, the torque value and the braking value are extracted from a speed profile to control the opening and closing speed or/and acceleration of each of the car doors respectively. They differ according to the direction (vertical or horizontal) and angle of the slope.

Next, the stop determination unit 20, which is an additional element of the exemplary embodiment of the present prevention, determines whether the vehicle is stopped in association with various devices equipped in the vehicle. Here, ‘stop’ means a state which is safe to open or close the vehicle door rather than simply a stopping state. Thus, in some instances the vehicle may still be rolling slightly. The stop determination unit may be embodied as a sensor which senses the speed at which a vehicle is moving. Alternatively, the stop determination unit may be data received from the speedometer of the vehicle.

Preferably, the stop determination unit 20 determines whether the vehicle is stopped via a speedometer, a transmission, a position of brake pedal and an ignition switch, or the like. Here, the determination of the stop of vehicle can be done by a combination of at least one or more elements among a vehicle speed of zero, the transmission P (parking) mode, the braking state, ignition on-off state.

Alternatively, the stop determination unit 20 may determine that the vehicle is stopped by collecting various information (speed information, mode information of transmission, brake state information, ignition on-off) from an electronic control unit (ECU) equipped in the vehicle.

The slope measurement unit 30, as an example, measures the vertical and horizontal slope of vehicle through the use of, for example, a 3-axis G (gravity) sensor. Namely, the slope measurement unit 30 measures the direction (vertical or horizontal direction) and angle of the vehicle slope.

The opening and closing detection unit 40 detects a variation in speed exerted by user's force and detects whether the door is being opened or closed by the user. Namely, the opening and closing detection unit 40 detects the opening of the door by detecting variations in speed when the user opens the door when the door is currently closed, whereas it detects the closing of the door by detecting variations in speed when the user closes a door that is currently open.

The door drive unit 50 opens and closes the door with a reference speed under the control of the controller 70. Namely, the door drive unit 50 controls the speed of opening and closing of the door by driving a motor based on the received torque value or braking value from the controller 70.

The object detection unit 60, which is an additional element of the illustrative embodiment of the present invention, detects an object and a distance from the object the door of the vehicle is currently located. In other words, the object detection unit 60, which is equipped, for example, on an outer side of the door, detects nearby vehicles so as not to damage surrounding vehicles by the door when the door drive unit 50 opens the door.

The controller 70 checks the direction and angle of the slope measured by the slope measurement unit 30 when the opening or closing of the door is detected by the opening and closing detection unit 40 once the stop determination unit has determined that the vehicle is stopped, and controls the door drive unit 50 to control the opening and closing speed of the door based on the speed profile stored in the storage unit 10.

The controller 70 may also control the door drive unit 50 so that the opening and closing acceleration of the door does not exceed a specific reference value.

More specifically, the controller 70 is triggered when the stop determination unit 20 determines that the vehicle has come to a stop, and the opening and closing detection unit has detected that a door is being opened or closed. Once these conditions are met, the controller 70 determines whether the vehicle is on an inclination and if so an angle at which the vehicle is parked/stopped (i.e., the slope). Based on the type and degree of inclination, the controller then controls the door drive unit 50 to control the opening and closing speed of the door based on the speed profile stored in storage unit 10 corresponding to that specific angle and inclination type.

In some exemplary embodiments of the present invention, as the object detection unit 50 detects objects, the controller 70 controls the door drive unit 50 so that the door of the vehicle does not come in contact with the detected object.

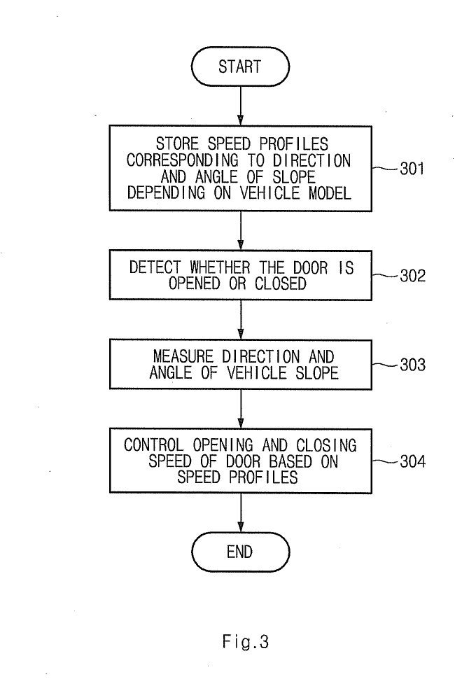

FIG. 3 is a flowchart illustrating a method for controlling a vehicle door according to an exemplary embodiment of the present invention.

Initially, the storage unit 10 stores a speed profile corresponding to the direction and angle of the slope depending on a specific vehicle model (301). Then, the opening and closing detection unit 40 detects whether the door is opened or closed (302). Next, the slope measurement unit 30 measures the direction and angle of the vehicle slope (303).

Then, the door drive unit 50, under the control of the controller 70, controls the opening and closing speed of the door based on the speed profile stored in the storage unit 10 (304). Here, the door drive unit 50, under the control of the controller 70, also can control the opening and closing speed of the door based on the speed profile stored in the storage unit 10 when the stop determination unit 20 determines that the vehicle is stopped.

In addition, when the object detection unit 60 detects a nearby object relative to the vehicle, the door drive unit 50 controls the door so that the door of the vehicle does not come into contact with the detected object through the control of controller 70. This process enables a user of a vehicle to easily open or close a door of a vehicle stopped/parked on a vertical or horizontal inclination.

Furthermore, the control logic of the present invention may be embodied as non-transitory computer readable media on a computer readable medium containing executable program instructions executed by a processor, the controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

As described above, according to the exemplary embodiment of the present invention, when the opening and closing direction of the door is opposite that of gravity, torque is generated to easily open and close the door, and when the opening and closing direction of the door is the same as gravity, the opening and closing speed are controlled by braking the pivotal swing of the door such that user can easily open and close the vehicle door when the vehicle is stopped/parked on a vertical or horizontal inclination.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for controlling a vehicle door, the apparatus comprising:
a storage unit configured to store a speed profile corresponding to a direction and angle of slope depending on a specific vehicle model;
a slope measure unit configured to measure a direction and angle of slope of a vehicle stopped on an inclination;
an opening and closing detection unit configured to detect whether a door of the vehicle is being opened or closed;
a controller configured to receive the direction and angle measured by the slope measure unit based upon whether the opening and closing detection unit detects that a door is being opened or closed, and wherein the controller is further configured to control a door drive unit to control an opening and closing speed of the door based on a corresponding speed profile stored in the storage unit; and
the door drive unit configured to open or close the door under the control of the controller.

2. The apparatus of claim 1, further comprising:
a stop determination unit configured to determine whether the vehicle is stopped.

3. The apparatus of claim 2, wherein the controller is configured to set a stop determination value of the stop determination unit to a first value for controlling the door drive unit.

4. The apparatus of claim 2, wherein the stop determination unit is configured to determine whether the vehicle is stopped based on at least one or more elements selected from a group consisting of a speed of the vehicle, a transmission mode, a braking state, and an ignition on-off state, as determination information.

5. The apparatus of claim 4, wherein the stop determination unit is configured to obtain the determination information from an electronic control unit (ECU) equipped in the vehicle.

6. The apparatus of claim 1, further comprising:
an object detection unit configured to detect a nearby object surrounding the vehicle.

7. The apparatus of claim 6, wherein the controller is configured to control the door drive unit so that the door of the vehicle does not come in contact with a detected object.

8. The apparatus of claim 1, wherein the direction of the slope is configured to contain at least one or more selected from a group consisting of a front facing slope, backward facing slope, left slope, and right slope.

9. A method for controlling a vehicle door, the method comprising:
storing a speed profile corresponding to a direction and angle of slope depending on a specific vehicle model, by a storage unit;
detecting whether a door of a vehicle is opened or closed, by an opening and closing detection unit;
measuring the direction and angle of slope of the vehicle, by a slope measure unit; and
controlling an opening and closing speed of the door based on the speed profile stored in the storage unit, by a door drive unit under the control of a controller.

10. The method of claim 9, wherein controlling the opening and closing speed of the door comprises controlling the opening and closing speed of the door when the vehicle is stopped.

11. The method of claim 10, wherein the stop state of the vehicle is determined by at least one selected from a group consisting of a speed, a transmission mode, a brake state, and an ignition on-off.

12. The method of claim 9, further comprising:
controlling the door not to come in contact with a nearby object surrounding the vehicle, by the door drive unit under the control of the controller.

13. A non-transitory computer readable medium containing program instructions executed by a controller, the computer readable medium comprising:
program instructions that store a speed profile corresponding to a direction and angle of slope depending on a specific vehicle model;
program instructions that interpret data indicating whether a door of a vehicle is opened or closed based upon detection from an opening and closing detection unit;
program instructions that interpret data indicating the direction and angle of slope of the vehicle measured by a slope measure unit; and
program instructions control opening and closing speed of the door based on the speed profile stored in the storage unit, by a door drive unit under the control of a controller.

14. The non-transitory computer readable medium of claim 9, wherein the program instruction that control the opening and closing speed of the door include program instructions that control the opening and closing speed of the door when the vehicle is stopped.

15. The non-transitory computer readable medium of claim 14, wherein the stop state of the vehicle is determined by at least one selected from a group consisting of a speed, a transmission mode, a brake state, and an ignition on-off.

16. The non-transitory computer readable medium of claim 13, further comprising:
program instruction that control the door not to come in contact with a nearby object surrounding the vehicle, by the door drive unit under the control of the controller.
